(19) United States
(12) Patent Application Publication
(10) Pub. No.: US 2023/0374354 A1
(43) Pub. Date: Nov. 23, 2023

(54) REDETACHABLE SELF-ADHESIVE PRODUCTS

(71) Applicant: tesa SE, Norderstedt (DE)

(72) Inventors: Jos TASCHE, Ahrensburg (DE); Imke SCHWARZ, Hamburg (DE); Thilo DOLLASE, Hamburg (DE); Julia GARBERS, Hamburg (DE); Jan Ole POEHLS, Hamburg (DE)

(73) Assignee: tesa SE, Norderstedt (DE)

(21) Appl. No.: 18/129,435

(22) Filed: Mar. 31, 2023

(30) Foreign Application Priority Data
Mar. 31, 2022 (DE) 102022107749.7

(51) Int. Cl. C09J 153/02; C09J 7/38; C09J 7/24; B32B 27/32; B32B 27/40

(52) U.S. Cl. CPC C09J 153/025; C09J 7/387; C09J 7/243; B32B 27/32; B32B 27/40; C09J 2301/502; C09J 2301/302; B32B 2255/12; B32B 2255/26; B32B 27/10

(57) ABSTRACT

Self-adhesive product redetachable by extensive stretching comprises a pressure-sensitive adhesive comprising: a) an elastomer component, where i. the elastomer component comprises a hydrogenated polyvinylaromatic-polydiene block copolymer described herein, ii. the polydiene blocks are substantially fully hydrogenated, iii. the hydrogenated polyvinylaromatic-polydiene block copolymer has a construction described herein, and iv. the elastomer component comprises a hydrogenated diblock copolymer having a construction described herein, b) a tackifying resin component, c) optionally a plasticizer, d) optionally further adjuvants, and also at least one ply of a temporary carrier material.

The present application claims priority of German Patent Application No. 10 2022 107 749.7, filed Mar. 31, 2022, the entire contents of which are hereby incorporated herein by reference.

The present invention relates in particular to double-sidedly adhering self-adhesive products which can be detached again from an adhesive bond by extensive stretching. They contain at least one layer of a pressure-sensitive adhesive based on hydrogenated polyvinylaromatic-polydiene block copolymers and are notable for very good thermal shear strength and longevity.

Adhesives and adhesive tapes are generally used to assemble two substrates to produce a durable or permanent connection. Trends have been apparent for some time already that are aimed at undoing such permanent connections for the purpose of recycling. Accordingly, adhesive solutions are sought that initially offer application-compatible bonding properties, and yet are also redetachable. A challenge here not least is to realize bonding performances that meet ever more demanding applications in relation, for example, to the materials to be bonded, but also to the robustness of the bond. For adhesive bonds in the automotive sector, for example, high thermal shear strengths are required, and on plastic add-on parts as well. A common material for such add-on parts is PP/EPDM, PP/EPM or PP/EPR. The bonding of such materials poses a particular challenge.

Self-adhesive products redetachable by extensive stretching and comprising one or more layers based on styrene block copolymers are known.

U.S. Pat. No. 4,024,312 A proposes multi-layer adhesive strips for medical applications, based on an extensible carrier layer and on an ABA block copolymer-based pressure-sensitive adhesive layer. The extensibility of the carrier is said to be at least 200% and the 50% modulus less than about 14 MPa. ABA block copolymers which may be utilized include those with B blocks composed of butadiene, isoprene, ethylene or butylene. Explicitly stated for carrier layers are SBS and SIS, for pressure-sensitive adhesive layers only SIS.

U.S. Pat. No. 6,372,341 B1 identifies a series of possible elastomers for extensible carrier layers, making particular mention of LLDPE, LDPE, SIS and SEBS. Adhesives explicitly stated are based in numerous examples on polyacrylates, and carrier layers on LLDPE or LDPE. Also identified is an extensible adhesive strip, which comprises an SEBS carrier and a resin-modified SIS adhesive.

DE 10 2012 223 670 A1 claims adhesive strips redetachable by extensive stretching, the strips having a multi-layer design with a polyurethane-based carrier layer and at least one pressure-sensitive adhesive layer composed of a formulation based on a vinylaromatic block copolymer. Preferred and explicitly stated are vinylaromatic block copolymers having unsaturated polydiene elastomer blocks.

Although the systems proposed are exceptionally suitable for many applications, there is a further desire to offer self-adhesive products which are redetachable by extensive stretching and which can be removed again even from very long-lived adhesive bonds. For formulations with very long-term stability, in principle, styrene block copolymer types are offered which have hydrogenation in the polydiene block, referred to as hydrogenated polystyrene-polydiene block copolymers. These are more particularly polystyrene-poly(ethylene/butylene), SEBS, and polystyrene-poly(ethylene/propylene), SEPS, block copolymers.

In the designing of self-adhesive products which are redetachable by extensive stretching it should be ensured that the force required for the stretching is not too high, since otherwise there may be unwanted tearing of the self-adhesive product before the detachment process is fully concluded. Moreover, high forces required for the stretching are typically not accepted by users. A first, rough, preliminary selection of potentially suitable base elastomers for formulations of self-adhesive tapes redetachable by extensive stretching can be made by the skilled person by way of the 300% modulus. This mechanical property is a common manufacturer specification for thermoplastic elastomers. It is recognized here, however, that polystyrene-polydiene block copolymers typically have a significantly lower 300% modulus (for SIS and SBS typically less than 3.5 MPa; cf. “Innovation powered by Kraton Polymers Product Guide”, Kraton Performance Polymers, Inc., 2016) than hydrogenated elastomers (for SEBS with about 30 wt % polystyrene fraction, typically higher than 4 MPa; cf. “Innovation powered by Kraton Polymers Product Guide”, Kraton Performance Polymers, Inc., 2016), and so it is not obvious that hydrogenated polystyrene-polydiene block copolymers can be used to access formulations suitable for self-adhesive products that are redetachable by extensive stretching.

There have nevertheless been attempts to propose formulations, suitable for self-adhesive products redetachable by extensive stretching, on the basis of hydrogenated polystyrene-polydiene block copolymers (DE 100 03 318 A1, DE 102 52 088 A1, DE 102 52 089 A1, DE 10 2007 021 504 A1).

DE 100 03 318 A1 cites self-adhesive strips which are 700 μm thick, are redetachable by extensive stretching, and are intended in particular for the securement of wall hooks. Illustratively, formulations based on hydrogenated polystyrene-polydiene block copolymers are also identified. The performance capacity of formulations with a triblock copolymer and one or two tackifying resins, however, is described as not meeting the requirements. Only formulations which contain two kinds of hydrogenated polystyrene-polydiene block copolymers—one with a polystyrene fraction of at least 25 wt % and one with a polystyrene fraction of at most 20 wt %—produce formulations that meet the requirements. This shows that it is a demanding task to design a formula, based on hydrogenated polystyrene-polydiene block copolymers, which may per se be redetachable by extensive stretching, that also operates with appropriate performance in the sense of the bonding requirements for a particular given application.

DE 102 52 088 A1 discloses adhesive strips redetachable by extensive stretching, in single-layer and multi-layer designs. Single-layer adhesive strips identified here, based on SEBS, exhibit inadequate tear resistance in spite of a product thickness of 700 μm. For multi-layer product designs, the examples utilize SIS-based formulations, which have a maximum extensibility of typically more than 1000%. The specification discloses formulations of very low (Kraton G1657: 13 wt %; Septon 2063: 13 wt %) and very high (Kraton GRP 6919: 40 wt %) polystyrene content. With the formulations specified it is not possible to obtain tear-stable, single-layer, self-adhesive products redetachable by extensive stretching. In order to get to tear-stable, self-adhesive products redetachable by extensive stretching, the introduction of a polystyrene-polydiene-based middle layer is proposed. The formulations with the hydrogenated polystyrene-polydiene block copolymers proposed therein can be expected to have limited thermal shear strength.

DE 102 52 089 A1, like DE 100 03 318 A1 as well, observes that self-adhesive strips 700 μm thick do not operate in accordance with requirements (in the context here of wall hook securement as well) unless hydrogenated polystyrene-polydiene block copolymers are combined in a specific way with other elastomers. This again underscores the particular challenge when the aim is to design self-adhesive strips redetachable by extensive stretching with pressure-sensitive adhesive formulations based on hydrogenated polystyrene-polydiene block copolymers, and to achieve a specific bonding performance.

DE 10 2007 021 504 A1 teaches single-layer adhesive strips which are redetachable by extensive stretching, which are based on SEBS or SEPS with a high fraction of plasticizing resin, in a product thickness of 700 μm. It proposes combinations of different hydrogenated polystyrene-polydiene block copolymers. Evidently, however, it has been recognized that hydrogenated polystyrene-polydiene block copolymers with a 300% modulus>3 MPa cannot be used on a majority basis within the elastomer component. In the example formulations explicitly given, therefore, the elastomer component is formulated with a high fraction of an elastomer of low polystyrene content (<15 wt %); while this may result in easy redetachability even on sensitive substrates, it is accompanied by a thermal shear strength that is inadequate for many industrial applications.

It is an object of the invention, therefore, to provide self-adhesive products which are redetachable by extensive stretching and have high long-term stability and which in spite of the detachability offer a good bonding performance even on non-polar substrates such as PP/EPDM, PP/EPM or PP/EPR and at the same time offer a heightened thermal shear strength as well.

This object is achieved unexpectedly by self-adhesive products which include at least one layer of a pressure-sensitive adhesive of the kind described in Claims 1 and 2. The dependent claims provide advantageous developments of the subject matter of the invention. A further part of the invention is a substrate, more particularly a component, which bears an adhered self-adhesive product of the invention.

A first subject of the present invention, therefore, is a self-adhesive product redetachable by extensive stretching and comprising at least one layer of a pressure-sensitive adhesive comprising:
a) at least 28 wt % and at most 58 wt % of an elastomer component, where
   i. the elastomer component comprises at least about 60 wt % and preferably at most about 90 wt %, based in each case on the elastomer component, of a hydrogenated polyvinylaromatic-polydiene block copolymer having a polyvinylaromatic fraction of at least 18 wt % and a peak molecular weight of 100 000 to 500 000 g/mol, determined by GPC (Test I),
   ii. the polydiene blocks are substantially fully hydrogenated,
   iii. the hydrogenated polyvinylaromatic-polydiene block copolymer has an ABA construction, (AB)ₙZ construction with n=2 or radial (AB)ₙ construction or radial (AB)ₙ-Z construction with n≥3, where A=polyvinylaromatic, B=ethylene and butylene or ethylene and propylene, and Z=derivative of a coupling substance, and where the ethylene fraction in the B blocks is preferably at least 50 wt %, and
   iv. the elastomer component comprises up to 35 wt %, based on the elastomer component, of at least one kind of a hydrogenated diblock copolymer having an A′B′ construction or (A′B′)ₙZ construction with n=1, where A′=polyvinylaromatic, B′=ethylene and butylene or ethylene and propylene, Z=derivative of a coupling substance, and A′ may=A and/or B′ may=B,
b) a tackifying resin component,
c) optionally a plasticizer component,
d) optionally further adjuvants,
where the fraction of the elastomer component is based on the total weight of the pressure-sensitive adhesive and also
at least one ply of a temporary carrier material (“release liner”).

According to a first preferred embodiment of the invention, the above self-adhesive product redetachable by extensive stretching and comprising at least one layer of a pressure-sensitive adhesive comprises not only the at least one ply of a temporary carrier material (“release liner”) but also at least one ply of an extensible permanent carrier material.

Furthermore, a second subject of the present invention is a self-adhesive product redetachable by extensive stretching and comprising at least one layer of a pressure-sensitive adhesive comprising:
a) at least 28 wt % and at most 58 wt % of an elastomer component, where
   i. the elastomer component comprises at least about 60 wt % and preferably at most about 90 wt %, based in each case on the elastomer component, of a hydrogenated polyvinylaromatic-polydiene block copolymer having a polyvinylaromatic fraction of at least 18 wt % and a peak molecular weight of 100 000 to 500 000 g/mol, determined by GPC (Test I),
   ii. the polydiene blocks are substantially fully hydrogenated,
   iii. the hydrogenated polyvinylaromatic-polydiene block copolymer has an ABA construction, (AB)ₙZ construction with n=2 or radial (AB)ₙ construction or radial (AB)ₙ-Z construction with n≥3, where A=polyvinylaromatic, B=ethylene and butylene or ethylene and propylene, and Z=derivative of a coupling substance, and where the ethylene fraction in the B blocks is preferably at least 50 wt %, and
   iv. optionally the elastomer component comprises up to 35 wt % based on the elastomer component of at least one kind of a hydrogenated diblock copolymer having an A′B′ construction or (A′B′)ₙZ construction with n=1, where A′=polyvinylaromatic, B′=ethylene and butylene or ethylene and propylene, Z=derivative of a coupling substance, and A may=A and/or B′ may=B,
b) a tackifying resin component,
c) a plasticizer component at not less than 2 wt % and not more than 30 wt %, and
d) optionally further adjuvants,
where the fraction of the elastomer component is based on the total weight of the pressure-sensitive adhesive
and also at least one ply of a temporary carrier material (“release liner”).

According to a further preferred embodiment of the invention, the above self-adhesive product redetachable by extensive stretching and comprising at least one layer of a pressure-sensitive adhesive comprises not only the at least one ply of a temporary carrier material (“release liner”) but also at least one ply of an extensible permanent carrier material.

By substantially fully hydrogenated in the context of the present invention is meant a degree of hydrogenation of at least 90%, preferably of at least 95% and more preferably of at least 99%. Hydrogenated block copolymers in the context of the present invention are those in which the polydiene blocks are in substantially fully hydrogenated form.

Examples of coupling substances which can be used in the invention can be found in—for instance—Holden (G. Holden, D. R. Hansen in “Thermoplastic Elastomers”, G. Holden, H. R. Kricheldorf, R. P. Quirk (Eds.), 3^{rd} Edn. 2004, C. Hanser, Munich, p. 49f), without wishing to impose any restriction.

A pressure-sensitive adhesive (PSA) is understood, in agreement with the general understanding, to be an adhesive which even under relatively weak contact pressure allows a durable connection to virtually all substrates and which optionally after use may be redetached from the substrate substantially without residue. At room temperature, a PSA has permanent pressure-sensitive adhesion, thus having a sufficiently low viscosity and high touch-tackiness, and so it wets the surface of the respective bonding substrate even at low contact pressure. The bondability of the adhesive derives from its adhesive properties, and the redetachability from its cohesive properties.

### Pressure-Sensitive Adhesive

Self-adhesive products of the invention redetachable by extensive stretching comprise at least one layer of a PSA formulation which preferably meets the performance requirements specified in the table below.

TABLE 1
Preferred performance profile

| | Measurement | | | | | | |
|---|---|---|---|---|---|---|---|
| Requirement | method | typical | | preferable | | very preferable | |
| Peel adhesion, | Test II | ≥3.0 | N/cm | ≥5.0 | N/cm | ≥6.0 | N/cm |
| steel, | | | | | | | |
| Peel adhesion, | Test III | ≥2.0 | N/cm | ≥4.0 | N/cm | ≥5.0 | N/cm |
| PP/EPR | | | | | | | |
| SAFT 200 g | Test IV | ≥115° | C. | ≥130° | C. | ≥160° | C. |

| | | | | |
|---|---|---|---|---|
| Detachment test | Test V | ≤25% | ≤15% | ≤10% |
| (rate of tears) | | | | |

### a) Elastomer Component

In the context of the present invention it has emerged in particular that the advantageous combination of properties, particularly the high shear strength at high temperatures, can be achieved through a balanced harmonization of the individual components of the PSA, but not by those widely disclosed in the prior art.

Suitability in the invention is possessed accordingly by formulations which contain at least 28 wt % and at most 58 wt %, preferably between 35 wt % and 55 wt %, very preferably between 40 wt % and 52 wt % of an elastomer component, the elastomer component containing at least 60 wt %, preferably at least 70 wt % and very preferably at least 80 wt % and at most 90 wt %, based on the elastomer component, of at least one first kind of a hydrogenated polyvinylaromatic-polydiene block copolymer.

The at least one first hydrogenated polyvinylaromatic-polydiene block copolymer used in the invention is notable for a linear ABA construction or linear (AB)ₙZ construction with n=2 or radial (AB)ₙ construction or radial (AB)ₙZ construction with n≥3. Vinylaromatics for constructing the block A comprise preferably styrene, α-methylstyrene and/or other styrene derivatives. The block A may therefore take the form of a homopolymer or a copolymer. More preferably the block A is a polystyrene. Block copolymers of this nature form the backbone of the formulation. They constitute a substantial part via which influence is exerted on the thermal shear strength and also on the tear resistance. However, too high a fraction or an unfavourable choice of the molar mass of block copolymers of this nature may reduce the peel adhesion. In order to balance out these properties in an optimal way, it has emerged that block copolymers of this nature ought to have a peak molecular weight of at least about 100 000 g/mol and at most about 500 000 g/mol. The higher the molecular weight, the more challenging the processing properties of the material. A peak molecular weight of at most 250 000 g/mol is therefore preferred. Very advantageous are linear triblock copolymers having a peak molecular weight of between 100 000 g/mol and 200 000 g/mol.

In order to attain a thermal shear strength compatible with the requirements, a minimum of 18 wt % of polyvinylaromatic fraction is selected in the at least one block copolymer of this nature. This fraction, however, ought again not to be too high, since if the fraction is too high the peel adhesion is reduced. It is advantageous if the polyvinylaromatic fraction is not higher than 35 wt %. A favourable polyvinylaromatic fraction is situated in a range between 20 wt % and 33 wt %. The fraction of polyvinylaromatic in the hydrogenated polyvinylaromatic-polydiene block copolymer may be determined, for example, by ¹H or ¹³C-NMR (nuclear magnetic resonance spectroscopy, Test XI). For commercially available hydrogenated polyvinylaromatic-polydiene block copolymers, the fraction of polyvinylaromatic may also be taken from the manufacturer specifications.

The hydrogenated polyvinylaromatic-polydiene block copolymers used in the PSA of the invention are preferably those whose vinylaromatic blocks (A blocks) contain styrene and which are formed by polymerization of dienes (B blocks) and subsequent hydrogenation, so that preferably ethylene and butylene or ethylene and propylene construct the B blocks. Preferred block copolymers used are those which in relation to the polydiene blocks (B blocks) are substantially completely hydrogenated. The ethylene fraction in the B blocks is preferably at least 50 wt %.

In order to improve further the profile of properties of the PSA of the invention, it has proven to be advantageous if the elastomer component, additionally to a hydrogenated polyvinylaromatic-polydiene block copolymer having a linear or radial construction, comprises a hydrogenated polyvinylaromatic-polydiene diblock copolymer A′B′, where A′ and B′ correspond preferably to A and B as defined above and the polydiene blocks are substantially fully hydrogenated; however, they may also differ in, for example, the molar mass and/or the composition.

In one preferred embodiment, the hydrogenated diblock copolymer is one having a peak molecular weight, determined by GPC (Test I), of less than 100 000 g/mol. The fraction of the hydrogenated diblock copolymer in the elastomer component is preferably not more than 35 wt %, preferably 10 to 25 wt %, based in each case on the total weight of the elastomer component.

In an additionally preferred embodiment, the elastomer component additionally comprises at least one hydrogenated diblock copolymer having a peak molecular weight, determined by GPC (Test I), of greater than 100 000 g/mol.

At least one kind of a hydrogenated diblock copolymer is used in particular when the formulation contains no plasticizer. Even in combination with plasticizers, however, it makes sense to use at least one kind of a hydrogenated diblock copolymer, since via hydrogenated diblock copolymers it is possible advantageously to exert influence over the peel adhesion and the flow-on behaviour.

The elastomer component, moreover, may comprise a further hydrogenated polyvinylaromatic-polydiene block copolymer which is distinguished by a linear ABA construction and also linear (AB)ₙZ construction with n=2 or radial (AB)ₙ construction and also radial (AB)ₙZ construction with n≥3. This block copolymer may have a polyvinylaromatic fraction of less than 18 wt % or more and independently thereof a peak molecular weight of more than 500 000 g/mol or less than 100 000 g/mol or in between. It may also comprise two or more of this nature.

### b) Tackifying Resin Component

The PSA of the invention additionally comprises a tackifying resin component. The fraction of the tackifying resin component, based on the total weight of the PSA, is typically 28 wt % to 55 wt %, preferably 35 wt % to 50 wt %. The tackifying resin component comprises one or more tackifying resins. The tackifying resins are selected such that they are primarily miscible (compatible) with the regions of the PSA that are dominated by the B blocks. At least one tackifying resin is notable, furthermore, for having a softening temperature by the ring-and-ball method of greater than 95° C., but not more than 135° C. The softening temperature here may be determined according to Test VI as described below. Preferably all of the tackifying resins in the tackifying resin component have a softening temperature within this range.

Tackifying resins used in the tackifying resin component are preferably those selected from the group consisting of partially or completely hydrogenated resin based on dicyclopentadiene, partially or completely hydrogenated hydrocarbon resins based on C₅, C₅/C₉ or C₉ monomer streams, polyterpene resins based on α-pinene and/or β-pinene and δ-limonene, and a hydrogenated polymer of pure C₈ or C₉ aromatics, where the resin is partially or, more particularly, completely hydrogenated.

“Partially hydrogenated” in the context of the present invention refers to a degree of hydrogenation of at least 80%, preferably at least 85%.

The adhesive of the invention preferably comprises at least one tackifying resin which has a DACP (diacetone alcohol cloud point) of at least 30° C., preferably of at least 40° C. The DACP may be determined here according to Test VII as described below.

In an additionally preferred embodiment, the PSA of the invention comprises at least one tackifying resin which has an MMAP (mixed methylcyclohexane aniline point) of greater than 60° C., preferably greater than 70° C. The MMAP may be determined according to Test VIII as described below.

As well as the at least one above-described tackifying resin, the tackifying resin component may also comprise one further or two or more further tackifying resins which do not meet the specified definitions in terms of softening temperature and/or DACP and/or MMAP cloud point. Hence it is also possible to use tackifying resins having a softening temperature of below 95° C., such as about 90° C. or about 85° C., in a fraction, based on the composition of the tackifying resin component, of up to 10 wt % or even up to 20 wt %. Hence it is also possible to use tackifying resins having a softening temperature of more than 135° C. such as about 140° C. at a fraction, based on the composition of the tackifying resin component, of up to 10 wt % or even up to 20 wt %.

It is also possible to use tackifying resins having an MMAP cloud point of below 60° C. or even below 45° C. and/or a DACP cloud point of below 30° C. or even below 15° C., with a fraction, based on the composition of the tackifying resin component, of up to 20 wt % or even up to 40 wt %. Examples of such tackifying resins are terpene-phenol resins in particular having an OH number of at most 100 mg KOH/g, and rosin esters, which may be partly hydrogenated, fully hydrogenated or disproportionated.

### c) Plasticizer Component

As well as the elastomer component and the tackifying resin component, the PSA of the invention may further comprise a plasticizer component. A plasticizer component is present whenever there is no diblock copolymer in the PSA. It is, however, also possible to utilize a plasticizer component in combination with a diblock copolymer.

The fraction of plasticizer component, based on the total weight of the PSA, is here preferably not more than 30 wt %, preferably 2 to 20 wt %, more preferably 4 to 15 wt %. It has surprisingly emerged that even a low fraction of plasticizer component in the stated quantities is sufficient to give a PSA having sufficiently high bond strength, in opposition to the teaching of the prior art, which assumes in some cases a plasticizer content of 60 to 95 wt %. It has surprisingly likewise emerged, moreover, that a relatively high plasticizer component fraction in the stated quantities still results in very good thermal shear strength, provided the formulation design and raw materials selection are both in accordance with the invention. The plasticizer component may comprise one or more plasticizers.

The plasticizer is preferably selected from the group consisting of ethylene/propylene copolymer, ethylene/butylene copolymer, butylene/isobutylene (co)polymer, butylene homopolymer and isobutylene homopolymer.

In an additionally preferred embodiment, the plasticizer has a weight-average molecular mass, determined by GPC (Test I), of at least 100 000 g/mol and at most 1 000 000 g/mol.

In these cases the plasticizer is preferably an ethylene/propylene copolymer or ethylene/butylene copolymer with linear or radial structure.

In an alternatively preferred embodiment, the plasticizer has a weight-average molar mass, determined by GPC (Test I), of at least 3000 g/mol and at most 20 000 g/mol. In this case the plasticizer is preferably a butylene/isobutylene (co)polymer.

Also suitable, surprisingly, are plasticizing resins based on rosin, more particularly methyl esters of rosin or of partly or fully hydrogenated rosin.

### d) Further Adjuvants

In order further to adapt the profile of properties of the PSA of the invention, it may be admixed with further adjuvants. These are preferably adjuvants selected from the group consisting of primary antioxidants such as sterically hindered phenols, secondary antioxidants such as phosphites or thioethers, process stabilizers such as C-radical scavengers, light stabilizers such as UV absorbers or sterically hindered amines, processing assistants, and further elastomers, such as those based on pure hydrocarbons such as unsaturated polydienes, naturally or synthetically generated polyisoprene or polybutadiene, elastomers with substantial chemical saturation such as saturated ethylene-propylene copolymers, α-olefin copolymers, polyisobutylene, butyl rubber, ethylene-propylene rubber, and functionalized hydrocarbons such as halogen-containing, acrylate-containing or vinyl ether-containing polyolefins. It is also possible to use organic or inorganic fillers, and also dyes and colour pigments.

### Self-Adhesive Products

As well as the at least one PSA layer, the self-adhesive tape of the invention comprises at least one ply of a temporary carrier material. This temporary carrier material is a film-like material from which a PSA layer can be detached, allowing the remaining part of the self-adhesive tape to be contacted subsequently with a substrate for bonding or with another material, which is intended to form an assembly with the remaining part of the self-adhesive tape.

The temporary carrier material is a release paper or a release film, also called release liner, and at any rate it is a material which is not fixedly connected to the PSA layer and which in particular is furnished abhesively, so that a PSA layer can be detached from it. It therefore constitutes an aid to the production or storage of the tape or to its further processing by die-cutting, for example. Finally, the pressure-sensitive adhesive strip may be lined on one or both sides with a liner. Especially if the pressure-sensitive adhesive strip is provided with a liner on one side only, this is a temporary carrier which has anti-adhesive coating on both sides.

Using the at least one aforesaid PSA, self-adhesive products of the invention may be designed in the form of
single-layer, double-sidedly self-adhesive tapes, known as “transfer tapes”, composed of a single layer of a PSA of the invention in combination with a temporary carrier material;
multi-layer, double-sidedly self-adhesive tapes, in which each of the layers consist of the PSAs of the invention, in combination with a temporary carrier material;
double-sidedly self-adhesively furnished adhesive tapes with an intermediate carrier (“permanent carrier material” or “permanent carrier”) which is arranged either in a layer of adhesive or between two layers of adhesive, in combination with a temporary carrier material.

Also a subject of the present invention, therefore, is a self-adhesive product with a temporary carrier material and a permanent carrier bearing at least one applied layer of the PSA of the invention. Likewise a subject of the invention is a self-adhesive product having a temporary carrier material and a permanent carrier bearing on both sides an applied layer of PSA of the invention, where the two layers may consist of the same or different PSAs. Furthermore, a subject of the invention is a self-adhesive tape having a temporary carrier material and a permanent carrier bearing on one side an applied layer of a PSA of the invention and on the other side a further applied adhesive which is not of the invention. The latter adhesive may be pressure-sensitive or non-pressure-sensitive and/or heat-sealable. The double-sided products here may therefore have a symmetrical or an asymmetrical product construction.

Preference is given to single-layer, double-sidedly self-adhesive tapes composed of a single layer of a PSA of the invention in combination with a temporary carrier material.

Also preferred is an embodiment of the self-adhesive product in which the permanent carrier consists only of a single layer of a polymer film.

The permanent carrier is preferably a film. Encompassed in particular by the inventive concept are constructions having an extensible permanent carrier in the middle of the pressure-sensitive adhesive strip, more particularly in the middle of the single PSA layer, where the extensibility of the intermediate carrier must be sufficient to ensure detachment of the adhesive strip by extensive stretching. Highly extendable films, for example, may serve as permanent carriers. Examples of extensible permanent carriers which can be used advantageously are transparent embodiments from WO 2011/124782 A1, DE 10 2012 223 670 A1, WO 2009/114683 A1, WO 2010/077541 A1, WO 2010/078396 A1. However, the permanent carrier does not have to be transparent. It may in particular also be black, grey, white or coloured.

The permanent carrier film is produced using film-forming or extrudable polymers, which additionally may have undergone monoaxial or biaxial orientation.

In one preferred version, polyolefins are used. Preferred polyolefins are produced from ethylene, propylene, butylene and/or hexylene, where in each case the pure monomers may be polymerized or mixtures of the stated monomers are copolymerized. Through the polymerization process and through the selection of the monomers it is possible to control the physical and mechanical properties of the polymer film, such as the softening temperature and/or the tear resistance, for example.

Polyurethanes can be used excellently as starting materials for extensible permanent carrier layers. Polyurethanes are chemically and/or physically crosslinked polycondensates, which are typically synthesized from polyols and isocyanates. Depending on the nature of the individual components and the proportion in which they are used, extensible materials are obtainable which can be employed advantageously for the purposes of this invention. Raw materials available to the formulator for this purpose are stated for example in EP 0 894 841 B1 and EP 1 308 492 B1. The skilled person is aware of further raw materials from which permanent carrier layers of the invention may be constructed. Polyester polyurethanes, polyether polyurethanes and polycaprolactone polyurethanes may be given here as examples of polyurethanes which can be utilized advantageously in the sense of this invention as base material for permanent carriers.

It is advantageous, furthermore, to employ ethylene-vinyl acetate (EVA) copolymer-based materials in permanent carrier layers in order to produce extensibility.

Able to be used for particular advantage as materials for extensible permanent carrier layers are block copolymers. In these, individual polymer blocks are linked covalently to one another. The block linkage may be in a linear form, or else in a star-shaped form or as a graft copolymer variant. An example of an advantageously employable block copolymer is a linear triblock copolymer whose two terminal blocks have a softening temperature of at least 40° C., preferably at least 70° C., and whose middle block has a softening temperature of at most 0° C., preferably at most −30° C. Higher block copolymers, such as tetrablock copolymers are likewise employable. It is important that there are at least two polymer blocks of the same or different nature in the block copolymer that have a softening temperature in each case of at least 40° C., preferably at least 70° C., and that are separated from one another in the polymer chain via at least one polymer block having a softening temperature of at most 0° C., preferably at most −30° C. Examples of polymer blocks are polyethers such as, for example, polyethylene glycol, polypropylene glycol or polytetrahydrofuran, polydienes, such as, for example, polybutadiene or polyisoprene, hydrogenated polydienes, such as, for example, polyethylene-butylene or polyethylene-propylene, polyesters, such as, for example, polyethylene terephthalate, polybutanediol adipate or polyhexanediol adipate, polycarbonate, polycaprolactone, polymer blocks of vinylaromatic monomers, such as, for example, polystyrene or poly-[α]-methylstyrene, polyalkyl vinyl ethers, polyvinyl acetate, polymer blocks of [α],[β]-unsaturated esters such as, in particular, acrylates or methacrylates. The skilled person knows of corresponding softening temperatures. Alternatively the skilled person looks them up in, for example, the “Polymer Handbook” [J. Brandrup, E. H. Immergut, E. A. Grulke (Eds.), “Polymer Handbook”, 4^{th} Edn. 1999, Wiley, New York]. Polymer blocks may be constructed of copolymers.

With further preference the carrier is a foam carrier, more preferably a foam carrier composed of a PE or PU foam. In this case the foam may have any known form of foam cells, i.e. may be open-celled or closed-celled. The foaming may have been brought about by chemical or physical foaming means, by introduction of gas or, in particular, air (“frothing”), or by introduction of hollow beads, without this listing being conclusive—instead it should be understood merely by way of example. Specific examples are hollow glass beads, hollow ceramic beads, hollow metal balls and expanded, expandable and pre-expanded microballoons. Combinations of different stated and further foaming methods are likewise possible.

To produce a permanent carrier it may be appropriate here as well to add additives and further components which improve the film-forming properties, reduce the tendency for crystalline segments to form, where present and desirable, and/or specifically improve or else possibly impair the mechanical properties.

The permanent carriers may have a multi-ply configuration.

Furthermore, the permanent carriers may have outer layers, such as blocking layers, which prevent the penetration of components from the adhesive into the permanent carrier or vice versa. These outer layers may also have barrier properties, in order thus to prevent diffusive transit of water vapour and/or of oxygen.

For better anchorage of the PSAs on the permanent carrier, the permanent carriers may be pretreated by the known measures such as corona, plasma or flaming. The use of a primer is also possible. Ideally, however, there is no need for any pretreatment.

The reverse side of the permanent carrier may have undergone an anti-adhesive physical treatment or coating.

The thickness of the permanent carrier layer is typically in the range from 10 to 200 μm, preferably between 20 and 100 μm.

The strain (“stripping force”, Test IX) at 50% elongation ought to be less than 20 N/cm, preferably less than 10 N/cm, in order to enable easy detachment without excessive application of force.

A particularly advantageous self-adhesive product consists of
a single-layer permanent carrier (intermediate carrier), preferably composed of polyurethane, the carrier having an elongation at break of at least 100%, preferably at least 300%, and optionally a resilience of more than 50% (Test X), where
a layer of adhesive composed of the adhesive of the invention is applied on each of the two sides of the carrier, the adhesive being based preferably on hydrogenated vinylaromatic block copolymers and tackifying resins, where more preferably the composition of the adhesives is identical.

A further particularly advantageous self-adhesive product consists of
a single-layer permanent carrier (intermediate carrier), preferably containing polyolefin, the carrier having an elongation at break of at least 100%, preferably at least 300%, and optionally a resilience of less than 50% (Test X), where
a layer of the pressure-sensitive adhesive, preferably based on hydrogenated vinylaromatic block copolymers and tackifying resins, is applied on each of the two sides of the carrier, where more preferably the composition of the adhesives is identical.

The general expressions “self-adhesive product” and “self-adhesive tape” encompass, in the sense of this invention, all sheetlike structures such as two-dimensionally extended films or film portions, tapes with extended length and limited width, tape portions and the like, and also, lastly, die-cuts or labels.

The self-adhesive product therefore has a longitudinal extent and a lateral extent. The adhesive tape, extending perpendicularly to the two extents, also has a thickness, and the lateral extent and longitudinal extent may be greater by a multiple than the thickness. The thickness is as far as possible the same, preferably substantially the same, over the entire surface extent of the self-adhesive product as defined by length and width.

Typical converted forms of the self-adhesive products of the invention are adhesive tape rolls and also self-adhesive strips, of the kind obtained, for example, in the form of die-cuts. Preferably all of the layers have substantially the form of a cuboid. With further preference all of the layers are joined to one another over the full area.

Optionally there may be a non-adhesive finger tab region provided, from which the detachment operation can be performed.

The self-adhesive product preferably has a thickness of 20 μm to 2000 μm, more preferably of 30 to 1500 μm, particularly preferably 50 to 1000 μm or 100 μm, 150 μm, 200 μm, 250 μm or 500 μm, not including the temporary carrier material.

In a preferred embodiment of the self-adhesive product the permanent carrier has a thickness of between 20 and 100 μm, preferably 30 μm to 60 μm, and the identical PSA layers on the permanent carrier each have a thickness of between 20 and 100 μm, preferably 30 μm to 60 μm.

Another preferred embodiment of the self-adhesive tape comprises no permanent carrier and has the PSA as a singular layer on a temporary carrier material. The PSA layer has a thickness of between 100 μm and 2000 μm, more particularly between 200 μm and 1500 μm or between 400 μm and 1200 μm.

The self-adhesive product of the invention, redetachable by extensive stretching, may preferably be removed by extensively stretching it preferably substantially in the bond plane, in other words at a peel angle of about 0°, allowing it to be redetached without residue or destruction.

Removal, however, is also possible at other peel angles such as 45° or 90°.

### Production Processes

The PSA for the self-adhesive product of the invention is applied either to one side of a temporary carrier material or to one side of a permanent carrier. The PSA may be applied to the carrier by processes known to the skilled person, as for example by means of knife processes, nozzle knife processes, rolling-rod nozzle processes, extrusion die processes, casting die processes and casting processes. Likewise in accordance with the invention are application processes such as roll application processes, printing processes, screen-printing processes, half tone roll processes, inkjet processes and spraying processes. One preferred coating variant is solvent-based. For that process the constituents of the one or more PSAs are dissolved in a suitable solvent or solvent mixture and then coated from solution, and the coated material is dried. Suitable solvents, which may also be used in combination, are aliphatic (for example pentane, hexane, heptane, octane and structural isomers thereof), cycloaliphatic (for example cyclohexane and methylcyclohexane) and aromatic hydrocarbons (for example toluene, xylene), especially in combination with ketones (for example acetone, 2-butanone, isobutyl ketone) or esters (for example ethyl acetate, butyl acetate, propyl acetate, isopropyl acetate). An advantageous procedure uses a mixture of toluene and ethyl acetate. Very advantageous is a mixture of methylcyclohexane and an ester such as ethyl acetate or, in particular, butyl acetate. Advantage is possessed, moreover, by a mixture of cyclohexane and an ester, especially butyl acetate.

A further preferred production variant are hotmelt processes, in which the PSA is mixed by means of a compounding unit and is applied, in particular directly thereafter (“inline”), to the carrier material by means of extrusion and/or die and/or calender. The process for applying it need not, however, involve direct coating. The PSA may also be first coated in another way and laminated onto the carrier in a second step. If desired, further layers or plies of material may subsequently be coated or laminated on inline or offline, allowing multi-layer/multi-ply product constructions to be generated as well. Such further layers may introduce specific additional properties into the adhesive tape, such as the mechanical properties, for example. They may also promote anchorage between adhesive and carrier or suppress the migration of individual constituents from one layer into the other.

For product constructions with an intermediate carrier layer, a PSA layer may be realized through direct coating onto the permanent carrier material or by lamination, more particularly hot lamination.

### Use

The self-adhesive products of the invention are outstandingly suitable for long-term-stable permanent bonding, where there is a requirement for high thermal shear strength and also for separability of the bonded assembly. The separability requirement in the case of a permanent bond may be for purposes of reworking (if a bond is to be corrected in the process of producing an article), for purposes of repair (if a defective component in the bonded assembly is to be replaced) or for purposes of recycling (if, after a period of utilization of the bonded assembly, it is to be disposed of with its constituent materials separated). Self-adhesive compositions with the PSAs described here have proven to be advantageous, furthermore, particularly in conjunction with low-energy surfaces such as PP/EPDM, PP/EPM and PP/EPR. A further subject of the present invention, accordingly, is the use of the PSA of the invention or of the adhesive tape of the invention for bonding a substrate comprising ethylene (co)polymer, propylene (co)polymer, EPR, EPM and/or EPDM or else another plastic. In particular the PSA of the invention or the adhesive tape of the invention is used for bonding an add-on part comprising ethylene (co)polymer, propylene (co)polymer, EPR, EPM and/or EPDM or else another plastic such as ABS or polycarbonate in or on an automobile/vehicle. The longevity of the PSA of the invention also allows other materials to be bonded, such as glass, ceramic and metal.

A further subject of the present invention, therefore, is the use of the PSA of the invention or of the adhesive tape of the invention for the bonding of other substrates such as, in particular, other plastics and metals.

Long-term stability is achieved through utilization, in accordance with the invention, of hydrogenated polyvinylaromatic-polydiene block copolymers, which are known to possess enhanced heat, UV and weathering stability (F. C. Jagisch and J. M. Tancrede in D. Satas, “Handbook of Pressure Sensitive Adhesive Technology”, 3^{rd} edn., 1999, D. Satas & Associates, Warwick, p. 367, table 16-5).

The present invention is elucidated in more detail by means of the following examples which should in no way be interpreted as imposing any limitation on the concept of the invention.

### Test Methods

The measurements are carried out—unless expressly stated otherwise—under test conditions of 23±1° C. and 50±5% relative humidity.

### Test I—Molar Mass (GPC)

(a) Peak Molar Mass of Individual Block Copolymer Modes

Polymers are polymodal systems in terms of the molar mass distribution. Mixtures of different polymers may be interpreted as multimodal systems, with each polymer introducing its own molar mass distribution. Mixtures of block copolymers with structures having different molar mass distributions may likewise be interpreted as multimodal systems. Each block copolymer then brings in its own molar mass distribution. For the sake of simplicity, these are referred to here as block copolymer modes.

GPC is appropriate as a metrological method for determining the molar mass of individual polymer modes in mixtures of different polymers. For the block copolymers which can be used in the sense of this invention, produced by living anionic polymerization, the molar mass distributions are typically narrow enough to allow polymer modes—which can be assigned to triblock copolymers, diblock copolymers or multiblock copolymers—to appear with sufficient resolution from one another in the elugram. It is then possible to read off the peak molar mass for the individual polymer modes from the elugrams.

Peak molar masses (Peak MM) are determined by gel permeation chromatography (GPC). The eluent used is THF. The measurement is made at 23° C. The pre-column used is PSS-SDV, 5μ, 10³ Å, ID 8.0 mm×50 mm. For separation, the columns used are PSS-SDV, 5μ, 10³ Å and also 10⁴ Å and 10⁶ Å each with ID 8.0 mm×300 mm. The sample concentration is 4 g/l, the flow rate 1.0 ml per minute. Calibration is carried out using the commercially available ReadyCal kit Poly(styrene) high from PSS Polymer Standard Service GmbH, Mainz. (μ=μm; 1 Å=10⁻¹⁰ m).

(b) Weight-Average Molar Mass, Especially of Plasticizers

The weight-average molecular weight MW is determined by gel permeation chromatography (GPC). The eluent used is THF. The measurement is made at 23° C. The pre-column used is PSS-SDV, 5μ, 10³ Å, ID 8.0 mm×50 mm. For separation, the columns used are PSS-SDV, 5μ, 10³ Å and also 10⁴ Å and 10⁶ Å each with ID 8.0 mm×300 mm. The sample concentration is 4 g/l, the flow rate 1.0 ml per minute. Calibration is carried out using the commercially available ReadyCal kit Poly(styrene) high from PSS Polymer Standard Service GmbH, Mainz.

### Test II—Peel Adhesion, Steel or ABS

The determination of the peel adhesion (according to AFERA 5001) is conducted as follows. The defined adhesion substrate used is a polished steel plate 2 mm in thickness. The bondable sheetlike element under investigation (50 μm pressure-sensitive adhesive layer on 36 μm etched polyester film), unless otherwise indicated, is trimmed to a width of 20 mm and a length of about 25 cm, is provided with a handling section, and immediately thereafter is pressed down five times onto the respective adhesion substrate chosen, using a 4 kg steel roller and an advance rate of 10 m/min. Immediately after that, the bondable sheetlike element is pulled away from the adhesion substrate at an angle of 180° with a tensile tester (from Zwick) at a velocity v=300 mm/min, and the force required for this at room temperature is measured. The measured value (in N/cm) is obtained as a mean value from three individual measurements.

Instead of the steel plate indicated above, certain investigations determine the peel adhesion on a plastic plate made of ABS.

### Test III—Peel Adhesion, PP/EPR

The determination of the peel adhesion (according to AFERA 5001) is conducted as follows. The defined adhesion substrate used is a PP/EPR plate 2 mm in thickness. The bondable sheetlike element under investigation (50 μm pressure-sensitive adhesive layer on 36 μm etched polyester film) is trimmed to a width of 20 mm and a length of about 25 cm, is provided with a handling section, and immediately thereafter is pressed down five times onto the respective adhesion substrate chosen, using a 4 kg steel roller and an advance rate of 10 m/min. Immediately after that, the bondable sheetlike element is pulled away from the adhesion substrate at an angle of 180° with a tensile tester (from Zwick) at a velocity v=300 mm/min, and the force required for this at room temperature is measured. The measured value (in N/cm) is obtained as a mean value from three individual measurements.

The test substrate in this case is a PP/EPR plate. The base material for the PP/EPR plates is Hifax TRC 135X/4 Black from LyondellBasell.

### Test IV—SAFT

This test serves for rapid testing of the shear strength of adhesive formulations under temperature load. For this purpose, a test specimen for investigation is adhered to a temperature-controllable steel plate and loaded with a weight (200 g) and the shear distance is recorded.

### Sample Preparation:

The test specimen for investigation (50 μm transfer tape) is adhered, unless otherwise indicated, to an aluminium foil 50 μm thick by one of the adhesive sides. The test specimen thus prepared is cut to a size of 10 mm*50 mm.

The trimmed adhesive tape sample is bonded with the other adhesive side to a polished test plate cleaned with acetone (material 1.4301, DIN EN 10088-2, surface 2R, surface roughness Rₐ=30 to 60 nm, dimensions 50 mm*13 mm*1.5 mm), the bond being made such that the bond area of the sample in terms of height*width=13 mm*10 mm and the test plate protrudes by 2 mm at the upper edge. Subsequently a 2 kg steel roller is rolled over six times at a speed of 10 m/min for fixing. The sample is reinforced flush at the top with a stable adhesive strip which serves as a contact point for the distance sensor. The sample is then suspended by means of the plate such that the longer protruding end of the test specimen points vertically downwards.

### Measurement:

The sample for measurement is loaded at the bottom end with a weight of 200 g. The test plate with the bonded sample is heated starting at 25° C. at a rate of 9 K/min to the final temperature of 200° C.

The distance sensor is used to observe the slip distance of the sample as a function of temperature and time. The maximum slip distance is set at 1000 μm (1 mm); if exceeded, the test is discontinued and the failure temperature is noted. Test conditions: room temperature 23+/−3° C., relative humidity 50+/−5%. The result is reported as the mean value from two individual measurements, in ° C.

### Test V—Tear Resistance

For the tear resistance tests, adhesive tape specimens were produced as follows. Pressure-sensitive adhesive coatings of 50 μm were laminated onto both sides of a polyester polyurethane film 30 μm thick, which for this purpose had its protective film removed. These laminates were investigated in a three-layer construction. Transfer tape specimens with relatively high layer thickness were tested in the form of single-layer adhesive strip specimens. Ten strips each 10 mm wide and 40 mm long are punched from the adhesive tape under investigation. These strips are adhered over a length of 30 mm to a polycarbonate plate conditioned with ethanol, and so a finger tab 10 mm long protrudes. A second polycarbonate plate is applied to the second side of the bonded strips, specifically in such a way that the two polycarbonate plates lie flush over one another. The assembly is rolled over ten times using a 4 kg roller (five times back and forward). After a peel adhesion time of 24 h, the strips are stripped from the bond line manually, using the finger tab, at an angle of 180°.

An assessment is made of how many specimens can be detached again without residue. Tear resistance is reported as a percentage in relation to torn adhesive strips. 0% corresponds to the case in which, out of ten adhesive strips, none is torn during the attempted detachment performed by extensive stretching. 80% corresponds to the case in which, out of ten adhesive strips, eight adhesive strips are torn during the attempted detachment performed by extensive stretching.

### Test VI—(Tackifying) Resin Softening Temperature

For individual substances: the (tackifying) resin softening temperature (softening point; soft. point) is carried out according to the relevant methodology, which is known as ring & ball and is standardized according to ASTM E28.

### Test VII—DACP

5.0 g of test substance (the tackifying resin specimen under investigation) are weighed out into a dry test tube, and 5.0 g of xylene (isomer mixture, CAS [1330-20-7], ≥98.5%, Sigma-Aldrich #320579 or comparable) are added. The test substance is dissolved at 130° C. and the solution is then cooled to 80° C. Any xylene that has escaped is made up for with further xylene, so that 5.0 g of xylene are again present. Then 5.0 g of diacetone alcohol (4-hydroxy-4-methyl-2-pentanone, CAS [123-42-2], 99%, Aldrich #H41544 or comparable) are added. The test tube is shaken until the test substance has dissolved completely. For this purpose the solution is heated to 100° C. The test tube containing the resin solution is then introduced into a Novomatics Chemotronic Cool cloud point measuring instrument and heated therein to 110° C. Cooling is carried out at a cooling rate of 1.0 K/min. The cloud point is detected optically. For this purpose, the temperature at which the turbidity of the solution is 70% is registered. The result is reported in ° C. The lower the DACP, the higher the polarity of the test substance.

### Test VIII—MMAP

5.0 g of test substance (the tackifying resin specimen under investigation) are weighed out into a dry test tube, and 10 mL of dry aniline (CAS [62-53-3], ≥99.5%, Sigma-Aldrich #51788 or comparable) and 5 mL of dry methylcyclohexane (CAS [108-87-2], ≥99%, Sigma-Aldrich #300306 or comparable) are added. The test tube is shaken until the test substance has dissolved completely. For this purpose the solution is heated to 100° C. The test tube containing the resin solution is then introduced into a Novomatics Chemotronic Cool cloud point measuring instrument and heated therein to 110° C. Cooling is carried out at a cooling rate of 1.0 K/min. The cloud point is detected optically. For this purpose, the temperature at which the turbidity of the solution is 70% is registered. The result is reported in ° C. The lower the MMAP, the higher the aromaticity of the test substance.

### Test IX—Stripping Force

The detachment force (stripping force or stripping stress) is ascertained using an adhesive film with dimensions of 50 mm length×20 mm width and with a non-adhesive grip tab region at the upper end. The adhesive film is bonded between two congruent steel plates with dimensions of 50 mm×30 mm, using a pressing pressure of 50 newtons in each case. The steel plates at their lower end each have a drilled hole for receiving an S-shaped steel hook. The lower end of the steel hook carries a further steel plate, via which the test arrangement can be secured for measurement in the lower clamping jaw of a tensile testing machine. The bonds are stored for a time of 24 hours at +40° C. After reconditioning to room temperature, the adhesive film strip is detached at a tensile rate of 1000 mm per minute parallel to the bond plane and without contact with the edge regions of the two steel plates. During this procedure, a measurement is made of the required detachment force in newtons (N). The result reported is the mean value of the stripping stress values (in N per mm²), measured in the region in which the adhesive strip has detached from the steel substrates over a bond length of between 10 mm and 40 mm.

### Test X—Extensibility, Resilience

For measurement of the resilience, the self-adhesive strips are extended by 100%, held at this extension for 30 s, and then released. After a waiting time of 1 min, the length is measured again.

The resilience is then calculated as follows: RS=((L₁₀₀−L_{end})/L₀)·100, where RS=resilience in %.
L₁₀₀: length of the adhesive strip after extension by 100%
L₀: length of the adhesive strip before extension
L_{end}: length of the adhesive strip after relaxation for 1 min.

The resilience here corresponds to the elasticity.

The elongation at break, the tensile strength and the stress at 50% elongation are measured in accordance with DIN 53504 using size S3 dumbbell specimens and a separation velocity of 300 mm per minute. The test conditions are 23° C. and 50% relative humidity.

### Test XI—Polyvinylaromatic Fraction

The fraction of polyvinylaromatic blocks in hydrogenated polyvinylaromatic-polydiene block copolymers is determined using ¹³C-NMR unless otherwise known. The ¹³C-NMR is elucidated below using, as an example, the determination of the polystyrene fraction in hydrogenated polystyrene-polydiene block copolymers (SEPS). From the ¹³C spectrum, the mean value is formed from two integrals, namely the styrene-C signal at around 144 to 146 ppm and the styrene-CH at around 125 to 127 ppm correspondingly. This mean value is placed in relation, for SEBS, to the butylene integral (hydrogenated 1,2-polybutadiene repeat units), namely the CH3 signal at around 10 ppm, and to the ethylene integral (hydrogenated 1,4-polybutadiene repeat units), which may be obtained by calculation from the total-olefinic integral at around 20 to 50 ppm. The resulting fractions in mol % are then converted to wt %.

### I. Raw Materials Used

TABLE 2
Chemicals used

| | | | Manufac- |
|---|---|---|---|
| Component | Chemical | Description | turer |
| Elastomer | Kraton | SEBS; | Kraton |
| | G1652 | PS fraction 30 wt % | Corp. |
| | | Diblock fraction: 0 wt % | |
| | | Peak MW*: 71 000 g/mol | |
| | Kraton | SEBS; | Kraton |
| | G1650 | PS fraction 30 wt %; | Corp. |
| | | Diblock fraction: 0 wt % | |
| | | Peak MW*: 89 000 g/mol | |
| | Kraton | SEBS; | Kraton |
| | G1654 | PS fraction 31 wt %; | Corp. |
| | | Diblock fraction: 0 wt % | |
| | | Peak MW*: 160 000 g/mol | |
| | Kraton | SEBS; | Kraton |
| | G1651 | PS fraction 33 wt %; | Corp. |
| | | Diblock fraction: 0 wt % | |
| | | Peak MW*: 210 000 g/mol | |
| | Kraton | SEBS; | Kraton |
| | G1633 | PS fraction 30 wt %; | Corp. |
| | | Diblock fraction: 0 wt % | |
| | | Peak MW*: 365 000 g/mol | |
| | Kraton | SEBS; | Kraton |
| | G1657 | PS fraction 13 wt %; | Corp. |
| | | Diblock fraction: 29 wt % | |
| | | Peak MW*: 120 000 g/mol | |
| | Kraton | SEBS; | Kraton |
| | G1642 | PS fraction 21 wt %; | Corp. |
| | | Diblock fraction: 0 wt % | |
| | | Peak MW*: 112 000 g/mol | |
| | | Ethylene content: <50 wt % | |
| | Septon | SEPS; | Kuraray |
| | 2063 | PS fraction 13 wt %; | Co. |
| | | Diblock fraction: around 55 wt % | |
| | | Peak MW*: 165 000 g/mol | |
| | Kraton | SEBS; | Kraton |
| | G1726 | PS fraction 30 wt %; | Corp. |
| | | Diblock fraction: 70 wt % | |
| | | Peak MW*: 65 000 g/mol | |
| Resin | Eastotac | C₅ HC resin; | Eastman |
| | H100W | Soft. point: 100° C. | Chemical |
| | | MMAP: 82° C. | |
| | | DACP: 82° C. | |
| | | Fully hydrogenated | |
| | Regalite | C₉ HC resin; | Eastman |
| | R1125 | Soft. point: 125° C. | Chemical |
| | | MMAP: 88° C. | |
| | | DACP: 56° C. | |
| | | Fully hydrogenated | |
| | Regalite | C₉ HC resin; | Eastman |
| | R1100 | Soft. point: 100° C. | Chemical |
| | | MMAP: 75° C. | |
| | | DACP: 45° C. | |
| | | Fully hydrogenated | |
| | Regalite | C₉ HC resin; | Eastman |
| | R1090 | Soft. point: 90° C. | Chemical |
| | | MMAP: 77° C. | |
| | | DACP: 39° C. | |
| | | Fully hydrogenated | |
| | Dercolyte | Alpha-pinene resin | DRT |
| | A115 | Soft. point: 115° C. | |
| | | MMAP: 80° C. | |
| | | DACP: 28° C. | |
| | Foral | Pentaerythritol ester of | Eastman |
| | 105E | hydrogenated rosin | Chemical |
| | | Soft. point: 105° C. | |
| | | MMAP: 16° C. | |
| | | DACP: −50° C. | |
| Plasticizer | Kraton | Ethylene-propylene copolymer | Kraton |
| | G1750 | Peak MW: 390 000 g/mol | Corp. |
| | | MW: 365 000 g/mol | |
| | TerPIB | Polybutene | ter Hell |
| | 2600 | Peak MW: 11 000 g/mol | |
| | | MW: 9200 g/mol | |
| | TerPIB | Polybutene | ter Hell |
| | 1300 | Peak MW: 3500 g/mol | |
| | | MW: 3700 g/mol | |
| | TerPIB | Polybutene | ter Hell |
| | 950 | Peak MW: 2100 g/mol | |
| | | MW: 2500 g/mol | |
| | Regalite | Liquid hydrogenated HC resin | Eastman |
| | R1010 | Peak MW: 900 g/mol | Chemical |
| | | MW: 1000 g/mol | |
| | Pionier | Naphthenic mineral oil | Hansen & |
| | 2070P | Peak MW: 950 g/mol | Rosenthal |
| | | MW: 920 g/mol | |
| | Indopol | Polybutene | Ineos |
| | H6000 | Peak MW: 16 000 g/mol | |
| | | MW: 15 900 g/mol | |
| | Oppanol | Polyisobutylene | BASF |
| | B10 | Peak MW: 33 000 g/mol | |
| | | MW: 43 700 g/mol | |
| | Foralyn | Methyl ester of hydrogenated | Eastman |
| | 5020 | rosin | Chemical |
| | | Peak MW: 230 g/mol | |
| | | MW: 240 g/mol | |

SEPS: styrene-ethylene/propylene-styrene block copolymer
SEP: styrene-ethylene/propylene block copolymer
SEBS: styrene-ethylene/butylene-styrene block copolymer
PS fraction: polystyrene fraction
Peak MW: peak molecular weight
Peak MW*: peak molecular weight of the triblock copolymer
Peak MW**: peak molecular weight of the radial block copolymer
HC resin: hydrocarbon resin
Soft. point: softening point
MW: weight-average molecular weight

The permanent carrier used is a 30 μm polyester polyurethane film having an elongation at break of 650%, in the form of Platilon U04 from Covestro AG.

### II. Experiments

A series of test adhesive tape specimens were produced.

### Process P1 (Solvent Process):

The constituents of the PSAs here were dissolved at 30% in special boiling point spirit/toluene/acetone and coated out with a coating bar either onto a PET film furnished with a silicone release or onto an etched PET film in the desired coat thickness, after which the solvent was evaporated at 100° C. for 15 min and in this way the layer of adhesive was dried.

### Process P2 (Hotmelt Process):

The solvent-free production of pressure-sensitive adhesive formulations took place by means of a planetary roller extruder (PRE), which comprised an intake region and two process parts. The run-in rings had an increasing diameter in the process direction. Although different spindle fittings were suitable, preference was given to fittings that were at least ¾ of the maximum fitting number in the first process part. The elastomer components were metered in the intake of the PRE. The resin components were melted and added in the first process part of the PRE. A particularly suitable means of producing uniform mixtures was a resin split in which one portion of the resin was added in the intake region and the remainder downstream in the first process part. Particularly suitable here was the addition of both fractions in liquid form via a side feed or run-in rings, where the first fraction is around 30 wt % of the total amount of resin, and, unless stated otherwise, the process was implemented in this way. Another suitable option would be the addition of the first resin fraction in solid form in the intake of the PRE or via the side feed in the intake region.

Coating took place by introduction of the hot PSA compound into a 2-roll calender.

Table 2 shows the parameters of the hotmelt process.

| Total throughput of elastomer components | 10 | kg/h |
|---|---|---|
| Temp. of PRE central spindle | 50° | C. |
| Temp. of PRE zones | 160° C./160° C./160° C. | |
| PRE speed | 30 | rpm |

| | |
|---|---|
| Temp. of calender rolls | 180° C./180° C. |

The properties listed in the tables were then tested.

### EXAMPLES (“I” AS PER INVENTION; “C” COMPARATIVE)

(i) Multi-Layer, Carrier-Containing Product Constructions

| | I1.1 | I1.2 | I1.3 | I1.4 | I1.5 | I1.6 |
|---|---|---|---|---|---|---|
| Kraton | | | | | | |
| G1651 | | | | | | |
| Kraton | 40.0% | 40.0% | 40.0% | 40.0% | | 30.0% |
| G1654 | | | | | | |
| Kraton | 10.0% | 15.0% | 10.0% | 15.0% | | |
| G1726 | | | | | | |
| Kraton | | | | | 30.0% | |
| G1633 | | | | | | |
| Regalite | | 40.0% | 40.0% | | | |
| R1125 | | | | | | |
| Eastotac | 45.0% | | | | 43.0% | 43.0% |
| H100W | | | | | | |
| Dercolyte | | | | 40.0% | | |
| A115 | | | | | | |
| Regalite | | | | | | |
| R1010 | | | | | | |
| Ter Pib 2600 | | 5.0% | 10.0% | 5.0% | 27.0% | 27.0% |
| Kraton | 5.0% | | | | | |
| G1750 | | | | | | |

Figures in % are each wt %

| Tearing rate | 10% | | 0% | | 18% | | 0% | | 0% | | 20% | |
|---|---|---|---|---|---|---|---|---|---|---|---|---|
| Manual | | | | | | | | | | | | |
| (PC/PC)* | | | | | | | | | | | | |
| SAFT (200 | 171.5° | C. | 177.5° | C. | 127.3° | C. | 203.0° | C. | 137.0° | C. | 117.0° | C. |
| g)** | | | | | | | | | | | | |
| Peel | 5.5 | N/cm | 6.9 | N/cm | 7.6 | N/cm | 5.5 | N/cm | 4.0 | N/cm | 8.9 | N/cm |
| adhesion, | | | | | | | | | | | | |
| steel, fresh** | | | | | | | | | | | | |
| Peel | 3.6 | N/cm | 3.8 | N/cm | 6.7 | N/cm | 4.8 | N/cm | 8.1 | N/cm | 7.2 | N/cm |

adhesion,
PP/EPR**

*2 × 50 μm on 30 μm polyester polyurethane film
**50 μm on 36 μm polyester film

| | C2.1 | C2.2 | C2.3 | C2.4 | C2.5 | C2.6 |
|---|---|---|---|---|---|---|
| Kraton | 28.0% | 29.2% | 28.0% | 50% | | |
| G1657 | | | | | | |
| Kraton | 12.0% | 12.5% | 12.0% | | | 50% |
| G1650 | | | | | | |
| Septon 2063 | | | | | 50% | |
| Regalite | 26.0% | 50.0% | 26.0% | | 50% | 50% |
| R1100 | | | | | | |
| Regalite | | | | 50% | | |
| R1090 | | | | | | |
| Regalite | 34.0% | 8.3% | | | | |
| R1010 | | | | | | |
| Pionier | | | 34.0% | | | |
| 2070P | | | | | | |

Figures in % are each wt %

| Tearing rate | 95% | | 100% | | 100% | | 67.5% | | Not | | 60% | |
|---|---|---|---|---|---|---|---|---|---|---|---|---|
| Manual | | | | | | | | | determined | | | |
| (PC/PC)* | | | | | | | | | | | | |
| SAFT (200 | 94° | C. | 106° | C. | 80° | C. | 91° | C. | 96° | C. | 160° | C. |
| g)** | | | | | | | | | | | | |
| Peel | 5.1 | N/cm | 7.1 | N/cm | 0.3 | N/cm | 6.2 | N/cm | 11.4 | N/cm | 6.7 | N/cm |
| adhesion, | | | | | | | | | | | | |
| steel** | | | | | | | | | | | | |
| Peel | 4.2 | N/cm | 1.5 | N/cm | 0.4 | N/cm | 3.9 | N/m | 9.7 | N/cm | 3.7 | N/cm |

adhesion,
PP/EPR**

*2 × 50 μm on 30 μm polyester polyurethane film
**50 μm on 36 μm polyester film

| | I3.1 | I3.2 | C3.3 | C3.4 | I3.5 |
|---|---|---|---|---|---|
| Kraton G1652 | | | 40% | | |
| Kraton G1650 | | | | 40% | |
| Kraton G1654 | 40% | | | | 55% |
| Kraton G1651 | | 40% | | | |
| Kraton G1726 | 10% | 10% | 10% | 10% | |
| Regalite R1100 | 45% | 45% | 45% | 45% | 40% |
| Kraton G1750 | 5% | 5% | 5% | 5% | 5% |

Figures in % are each wt %

| | Tearing rate Manual (PC/PC)* | | | | | | | | | |
|---|---|---|---|---|---|---|---|---|---|---|
| | 0% | | 20% | | 0% | | 0% | | 20% | |
| SAFT (200 g)** | 192° | C. | 203° | C. | 110° | C. | 131° | C. | 180° | C. |
| Peel adhesion, | 6.3 | N/cm | 5.7 | N/cm | 2.2 | N/cm | 2.5 | N/cm | 5.1 | N/cm |
| steel** | | | | | | | | | | |
| Peel adhesion, | 2.2 | N/cm | 3.7 | N/cm | 0.1 | N/cm | 1.3 | N/cm | 2.9 | N/cm |
| PP/EPR** | | | | | | | | | | |

*2 × 50 μm on 30 μm polyester polyurethane film
**50 μm on 36 μm polyester film

| | I4.1 | I4.2 | I4.3 | C4.4 | I4.5 |
|---|---|---|---|---|---|
| Kraton G1654 | 40% | 40% | 40% | | 40% |
| Kraton G1651 | | | | 20% | |
| Kraton G1726 | 10% | 10% | 10% | | 10% |
| Regalite R1100 | 30% | 35% | 50% | | 35% |
| Foral 105-E | | | | | 10% |
| Eastotac H100W | | | | 42% | |
| TerPib 2600 | 20% | 15% | | 38% | 5% |

Figures in % are each wt %

| | Tearing rate Manual (PC/PC)* | | | | | | | | | |
|---|---|---|---|---|---|---|---|---|---|---|
| | 20% | | 0% | | 10% | | 33% | | 10% | |
| SAFT 200 g)** | 180° | C. | 125° | C. | 191° | C. | 112° | C. | 179° | C. |
| Peel adhesion, | 6.2 | N/cm | 5.1 | N/cm | 7.9 | N/cm | 14.2 | N/cm | 6.4 | N/cm |
| steel** | | | | | | | | | | |
| Peel adhesion, | 5.6 | N/cm | 3.3 | N/cm | 5.6 | N/cm | 9.4 | N/cm | 5.8 | N/cm |
| PP/EPR** | | | | | | | | | | |

*2 × 50 μm on 30 μm polyester polyurethane film
**50 μm on 36 μm polyester film

| | I5.1 | I5.2 | I5.3 | I5.4 | I5.5 |
|---|---|---|---|---|---|
| Kraton G1654 | 40% | 40% | 40% | 40% | 40% |
| Kraton G1726 | 10% | 10% | 10% | 10% | 10% |
| Regalite R1100 | 45% | 45% | 45% | 45% | 35% |
| Foral 105-E | | | | | 10% |
| Oppanol B10 | 5% | | | | |
| TerPib 950 | | 5% | | | |
| TerPib 1300 | | | 5% | | |
| Indopol H6000 | | | | 5% | |
| Foralyn 5020 | | | | | 5% |

Figures in % are each wt %

| | Tearing rate Manual (PC/PC)* | | | | | | | | | |
|---|---|---|---|---|---|---|---|---|---|---|
| | 10% | | 20% | | 0% | | 20% | | 20% | |
| SAFT (200 g)** | 171° | C. | 124° | C. | 198° | C. | 172° | C. | 177° | C. |
| Peel adhesion, | 4.8 | N/cm | 5.5 | N/cm | 4.9 | N/cm | 5.4 | N/cm | 6.6 | N/cm |
| steel** | | | | | | | | | | |
| Peel adhesion, | 2.7 | N/cm | 5.0 | N/cm | 3.8 | N/cm | 3.8 | N/cm | 5.5 | N/cm |
| PP/EPR** | | | | | | | | | | |

*2 × 50 μm on 30 μm polyester polyurethane film
**50 μm on 36 μm polyester film

| | C6.1 | C6.2 | C6.3 | C6.4 |
|---|---|---|---|---|
| Kraton G1654 | 30% | 20% | 45% | |
| Kraton G1726 | 20% | 5% | 15% | |
| Kraton G1642 | | | | 30% |
| Regalite R1100 | 45% | 45% | 35% | |
| Regalite R1090 | | | | 40% |
| Kraton G1750 | 5% | | | |
| Terpib 2600 | | 30% | 5% | |
| Oppanol B10 | | | | 30% |

Figures in % are each wt %

| Tearing rate Manual (PC/PC)* | |
|---|---|
| 100% | 100% |

| | | |
|---|---|---|
| SAFT (200 g)** | 83° | C. |
| Peel adhesion, | 1.4 | N/cm |
| steel** | | |
| Peel adhesion, | 4.3 | N/cm |
| PP/EPR** | | |

*2 × 50 μm on 30 μm polyester polyurethane film
**50 μm on 36 μm polyester film

| | I7.1 | I7.2 | I7.3 | I7.4 |
|---|---|---|---|---|
| Kraton G1654 | 40% | 37% | 35% | 35% |
| Kraton G1726 | 15% | 15% | 15% | 15% |
| Regalite R1100 | 40% | 43% | 45% | 31.5% |
| Regalite R1125 | | | | 13.5% |
| TerPib 2600 | 5% | 5% | 5% | 5% |
| Layer thickness | 530 μm | 1080 μm | 510 μm | 500 μm |

Figures in % are each wt %

| | Tearing rate Manual (PC/PC) | | | | | | | |
|---|---|---|---|---|---|---|---|---|
| | 0% | | 0% | | 0% | | 0% | |
| SAFT (200 g) | 162° | C. | 157° | C. | 138° | C. | 165° | C. |
| Peel adhesion, | 14.4 | N/cm | 23.8 | N/cm | 18.3 | N/cm | 24.3 | N/cm |
| steel* | | | | | | | | |
| Peel adhesion, | 12.7 | N/cm | 19.8 | N/cm | 14.5 | N/cm | 16.5 | N/cm |
| ABS* | | | | | | | | |

*on 75 μm polyester film

1. Self-adhesive product redetachable by extensive stretching and comprising at least one layer of a pressure-sensitive adhesive comprising:
a) at least 28 wt % and at most 58 wt % of an elastomer component, where
i. the elastomer component comprises at least 60 wt % and optionally at most 90 wt %, based in each case on the elastomer component, of a hydrogenated polyvinylaromatic-polydiene block copolymer having a polyvinylaromatic fraction of at least 18 wt % and a peak molecular weight of 100 000 to 500 000 g/mol, determined by GPC (Test I),
ii. the polydiene blocks are substantially fully hydrogenated,
iii. the hydrogenated polyvinylaromatic-polydiene block copolymer has an ABA construction, (AB)ₙZ construction with n=2 or radial (AB)ₙ construction or radial (AB)ₙ-Z construction with n≥3, where A=polyvinylaromatic, B=ethylene and butylene or ethylene and propylene, and Z=derivative of a coupling substance, and where the ethylene fraction in the B blocks is optionally at least 50 wt %, and
iv. the elastomer component comprises up to 35 wt %, based on the elastomer component, of at least one kind of a hydrogenated diblock copolymer having an A′B′ construction or (A′B′)ₙZ construction with n=1, where A′=polyvinylaromatic, B′=ethylene and butylene or ethylene and propylene, Z=derivative of a coupling substance, and A′ may=A and/or B′ may=B,
b) a tackifying resin component,
c) optionally a plasticizer component,
d) optionally further adjuvants,
where the fraction of the elastomer component is based on the total weight of the pressure-sensitive adhesive and also
at least one ply of a temporary carrier material (“release liner”).

2. Self-adhesive product redetachable by extensive stretching according to claim 1, wherein
the plasticizer component is present at not less than 2 wt % and not more than 30 wt %.

3. Self-adhesive product redetachable by extensive stretching according to claim 1, wherein
the self-adhesive product comprises not only the at least one ply of a temporary carrier material (“release liner”) but also at least one ply of an extensible permanent carrier material.

4. Self-adhesive product redetachable by extensive stretching according to claim 1, wherein
the fraction of elastomer component in the layer of the pressure-sensitive adhesive is 35 wt % to 55 wt %, based on the total weight of the pressure-sensitive adhesive.

5. Self-adhesive product redetachable by extensive stretching according to claim 1, wherein
the polyvinylaromatic-polydiene block copolymers have a polyvinylaromatic fraction of 18 wt % to 35 wt %.

6. Self-adhesive product redetachable by extensive stretching according to claim 1, wherein
the elastomer component, in addition to a hydrogenated polyvinylaromatic-polydiene block copolymer having a linear or radial construction, comprises a polyvinylaromatic-polydiene diblock copolymer AB, where with further preference A′=A and B′=B and the polydiene blocks are substantially fully hydrogenated.

7. Self-adhesive product redetachable by extensive stretching according to claim 6, wherein
the elastomer component comprises at least one diblock copolymer having a peak molecular weight, determined by GPC, of <100 000 g/mol and its fraction based on the elastomer component is at most 35 wt %.

8. Self-adhesive product redetachable by extensive stretching according to claim 1, wherein
the fraction of tackifying resin component is 28 to 55 wt %, based on the total weight of the pressure-sensitive adhesive.

9. Self-adhesive product redetachable by extensive stretching according to claim 1, wherein
the tackifying resin component comprises partially or completely hydrogenated resin based on dicyclopentadiene, partially or completely hydrogenated hydrocarbon resins based on C₅, C₅/C₉ or C₉ monomer streams, polyterpene resins based on α-pinene and/or β-pinene and δ-limonene, or a hydrogenated polymer of pure C₈ or C₉ aromatics, the resin being partially or completely hydrogenated.

10. Self-adhesive product redetachable by extensive stretching according to claim 1, wherein
the fraction of plasticizer in the pressure-sensitive adhesive is not more than 30 wt %, based on the total weight of the pressure-sensitive adhesive.

11. Self-adhesive product redetachable by extensive stretching according to claim 1, wherein
the plasticizer is selected from the group consisting of ethylene/propylene copolymer, ethylene/butylene copolymer, and butylene/isobutylene (co)polymer.

12. Self-adhesive product redetachable by extensive stretching according to claim 11, wherein
the plasticizer has a weight-average molar mass of at least 100 000 g/mol and at most 1 000 000 g/mol and is an ethylene/propylene copolymer or ethylene/butylene copolymer with linear or radial structure.

13. Self-adhesive product redetachable by extensive stretching according to claim 11, wherein
the plasticizer has a weight-average molar mass of at least 3000 g/mol and at most 20 000 g/mol and is a butylene/isobutylene (co)polymer.

14. Self-adhesive product redetachable by extensive stretching according to claim 1, wherein
said extensible permanent carrier material used comprises extensive films composed of polyolefins, of polyurethanes, of polyester polyurethanes, of polyether polyurethanes, of polycaprolactone polyurethanes, or of rubber-based materials.

15. Self-adhesive product redetachable by extensive stretching according to claim 1, wherein
the self-adhesive product is
a single-layer, double-sidedly self-adhesive tape, consisting of a single layer of the pressure-sensitive adhesive in combination with a temporary carrier material, or
a multi-layer, double-sidedly self-adhesive tape, in which the layers each consist of the pressure-sensitive adhesive in combination with a temporary carrier material, or
a multi-layer, double-sidedly self-adhesive tape having a permanent carrier which is arranged either in a layer of the pressure-sensitive adhesive or between two layers of the pressure-sensitive adhesive, in each case in combination with a temporary carrier material.

16. Self-adhesive product redetachable by extensive stretching according to claim 15, wherein
the self-adhesive product consists of
a single-layer permanent carrier (intermediate carrier), optionally containing polyolefin, the carrier having an elongation at break of at least 100%, and optionally a resilience of less than 50% (Test X), where
a layer of the pressure-sensitive adhesive is applied on each of the two sides of the carrier, the adhesive being based optionally on hydrogenated vinylaromatic block copolymers and tackifying resins, where optionally the composition of the adhesives is identical.

17. Self-adhesive product redetachable by extensive stretching according to claim 1, wherein
the self-adhesive product consists of
a single-layer permanent carrier, optionally composed of polyurethane, the carrier having an elongation at break of at least 100%, optionally at least 300%, and optionally a resilience of more than 50% (Test X), where
a layer of the pressure-sensitive adhesive is applied on each of the two sides of the carrier, where optionally the composition of the adhesives is identical.

18. Substrate comprising ethylene (co)polymer, propylene (co)polymer, EPR, EPM and/or EPDM, bearing an applied self-adhesive product according to claim 1.

19. A method of bonding a substrate comprising applying a self-adhesive product according to claim 1 to the substrate.
